(19) United States
(12) Patent Application Publication
(10) Pub. No.: US 2026/0361555 A1
(43) Pub. Date: Nov. 12, 2026

(54) Challenge-Response Architectures

(71) Applicant: Cirrus Logic International Semiconductor Ltd., Edinburgh (GB)

(72) Inventor: John P. LESSO, Edinburgh (GB)

(73) Assignee: Cirrus Logic International Semiconductor Ltd., Edinburgh (GB)

(21) Appl. No.: 19/426,624

(22) Filed: Dec. 19, 2025

Related U.S. Application Data
(60) Provisional application No. 63/803,068, filed on May 9, 2025.

(51) Int. Cl. H04L 9/32

(52) U.S. Cl. CPC H04L 9/3278

(57) ABSTRACT

Circuitry, comprising a challenge input for receiving a challenge signal, a memory comprising a memory array, wherein each entry in the memory array has a memory address, and processing circuitry. The processing circuitry configured to transform the challenge signal to obtain a transformed signal, wherein a bit-width of the transformed signal is larger than a bit-width of the challenge signal. The transformed signal representing a sequence of the memory addresses. The circuitry configured to generate a response signal based on the entries in the memory array at the memory addresses represented by the transformed signal.

### TECHNICAL FIELD

The present disclosure relates to challenge-response architectures.

### BACKGROUNDS

Challenge-response architectures are widely used in security systems. Physically unclonable functions (PUFs) are commonly used in cryptographic key generation, often as part of challenge-response architectures to store secret keys. Traditional PUFs leverage uncontrollable manufacturing variations in physical materials to produce unique and unpredictable responses to given inputs (referred to as challenges).

A stable PUF is a PUF which produces a consistent, identical output for a given input. When a stable PUF is required, either PUF enrolment (testing bit stability) or error correction may be performed. These mechanisms can introduce significant complexity, power, and area overhead.

### SUMMARY

According to a first aspect of the disclosure, there is provided circuitry, comprising: a challenge input for receiving a challenge signal; a memory comprising a memory array, wherein each entry in the memory array has a memory address; and processing circuitry configured to: transform the challenge signal to obtain a transformed signal, wherein a bit-width of the transformed signal is larger than a bit-width of the challenge signal, the transformed signal representing a sequence of the memory addresses; generate a response signal based on the entries in the memory array at the memory addresses represented by the transformed signal.

One or more of the entries may be stored in a one-bit memory element whose state is defined by its natural entropy.

Generating a response signal may comprise concatenating entries at the sequence of the memory addresses represented by the transformed signal.

The number of memory addresses in the memory array may be greater than the number of memory addresses in the sequence of memory addresses.

Each bit in the challenge signal may be transformed by the processing circuitry into a respective one of the memory addresses represented in the transformed signal.

The processing circuitry may be configured to: monitor the transformed signal; detect duplication of one or more of the memory addresses in the sequence; and discard the duplications in the transformed signal before generating the response.

The processing circuitry may be configured to transform the challenge signal such that the sequence comprises Y addresses, each having N bits, where AN≤X, where A is a positive integer, and where X is the number of entries in the memory array.

The processing circuitry may comprise one or more linear feedback shift registers (LFSRs).

The one or more LFSRs may be configured to receive the challenge signal as a seed.

The one or more LFSRs may comprise a plurality of LFSRs. The processing circuitry may be configured to select, based on the challenge signal, one or more of the plurality of LFSRs to generate the transformed signal.

Each of the plurality of LFSRs may have a different LFSR polynomial.

The processing circuitry may comprise a Stop-Go Geffe generator. The Stop-Go Geffe generator may comprise three or more LFSRs, each of the LFSRs initialized with a portion of the challenge signal.

The processing circuitry may comprise a shrinking generator. The shrinking generator may comprise a plurality of LFSRs and may be configured to implement irregular decimation. The shrinking generator may comprise a non-deterministic generator, comprising: a first LFSR configured to generate candidate bits; and a second LFSR configured to select a subset of the candidate bits.

The processing circuitry may be configured to transform the challenge signal by performing one or more of the following: accessing a look up table mapping the transform; implementing a fixed Boolean operation using one or more logic gates; implementing zero padding using one or more registers; and passing the challenge signal through a cryptographic cypher.

The cryptographic cypher may comprise a Feistel-type cypher. The processing circuitry may be configured to: zero-pad the challenge signal to obtain an expanded challenge signal and pass the expanded challenge signal through a plurality of rounds of the Feistel-type cypher.

The processing circuitry may be configured to implement the transform using a side-channel-robust shift register design. For example, the processing circuitry may comprise one or more side-channel LFSRs configured to process an inverse of the challenge signal in parallel to a respective one of the one or more LFSRs.

The processing circuitry may be configured to debias the transformed signal prior to generating the response.

The circuitry may further comprise an output configured to output the response signal.

According to another aspect of the disclosure, there is provided a physically unclonable function (PUF), comprising circuitry as described above.

According to another aspect of the disclosure, there is provided an electronic device, comprising circuitry or a PUF as described above.

The electronic device may further comprise host circuitry configured to generate the challenge signal and receive the response signal.

The electronic device may comprise one of a smartphone, a communications device, a mobile computing device, a laptop computer, a tablet computer, a games console, a remote-control device, a home automation controller or a domestic appliance, a toy, a robot, an audio player, a video player, and a mobile telephone.

According to another aspect of the disclosure, there is provided method of generating a response signal using a memory comprising a memory array, each entry in the memory array having a memory address, the method comprising: receiving a challenge signal; transforming the challenge signal to obtain a transformed signal, wherein a bit-width of the transformed signal is larger than a bit-width of the challenge signal, the transformed signal representing a sequence of the memory addresses; generating the response signal based on the entries in the memory array at the memory addresses represented by the transformed signal.

According to another aspect of the disclosure, there is provided a circuitry, comprising: a challenge input for receiving a challenge signal; a memory comprising a memory array, wherein each entry in the memory array has a memory address; and processing circuitry configured to: transform the challenge signal to obtain a transformed signal, wherein a size of a codebook of the transformed signal is larger than a size of a codebook of the challenge signal, the transformed signal representing a sequence of the memory addresses; generate a response signal based on the entries in the memory array at the memory addresses represented by the transformed signal.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the present disclosure will now be described by way of non-limiting examples with reference to the drawings, in which:

FIG. 1 is a schematic diagram of security circuitry;

FIG. 2 is an illustration of a memory array of the security circuitry;

FIG. 3 is an illustration of a process flow in the security circuitry;

FIG. 4 is a schematic diagram of an example implementation of processing circuitry of the security circuitry of FIG. 1;

FIG. 5 is a schematic diagram of an example implementation of an LFSR of the processing circuitry of FIG. 4;

FIG. 6 is a schematic diagram of an example implementation of processing circuitry of the security circuitry of FIG. 1;

FIG. 7 is a schematic diagram of an example implementation of processing circuitry of the security circuitry of FIG. 1;

FIG. 8 is a schematic diagram of an example implementation of processing circuitry of the security circuitry of FIG. 1; and

FIG. 9 is a flow diagram showing a method which may be implemented by the security circuitry of FIG. 1.

### DESCRIPTION OF EMBODIMENTS

In existing challenge-response architectures used in key-based authentication, a secret key is used to generate a response based on a challenge. It is known to store the secret key using a physically unclonable function (PUF). The PUFs used to store the secret keys must undergo enrolment or error correction procedures, due to the sensitivity of challenge-response algorithms to secret key variations.

Embodiments of the present disclosure aim to address or at least ameliorate one or more of the challenges associated with conventional challenge response architectures which utilise PUFs for storing private or secret keys. In particular, embodiments of the present disclosure aim to reduce the reliance on PUF stability by providing mechanisms for allowing a degree of bit-error-rate (BER).

To enable such advantages, it is proposed to provide a new challenge-response architecture in which security circuitry is configured to generate a response signal by first expanding a received challenge signal to create a transformed signal having a larger codebook than the challenge signal. The response signal is then generated by mapping the (expanded) transformed signal onto addresses in a memory. The transformed signal represents a sequence of memory addresses in the memory, and the response signal is generated based on entries in a memory at that sequence of memory addresses.

Challenge-response architectures known in the art are highly sensitive to the value of a secret key. In some architectures, a single bit flip in the secret key can cause the response signal to jump to an entirely separate pseudo-random response value. The proposed method avoids direct use of a secret key and thereby avoids direct use of raw PUF bit streams. In the proposed method, each bit of the response signal may be read from the value of a one-bit memory element, meaning a single bit flip in the value stored on a PUF device will cause, at most, a single bit flip in the response signal. This enables a more stable and cost-efficient response generation mechanism suitable for low-power and constrained devices, due at least in part to a greater tolerance for bit errors.

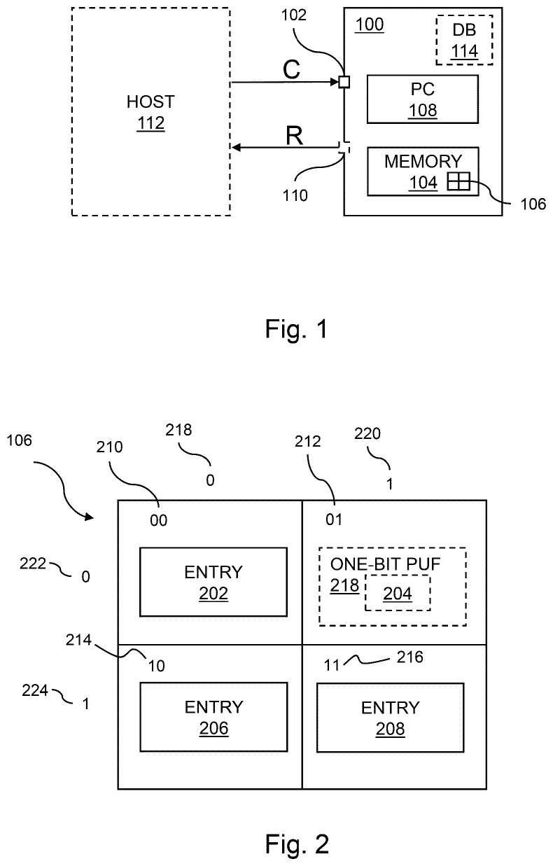

FIG. 1 is a schematic diagram of security circuitry 100 according to various embodiments of the present disclosure. The security circuitry 100 may form part of a physically unclonable function (PUF). The security circuitry 100 comprises a challenge input 102 for receiving a challenge signal C, a memory 104, and processing circuitry 108. The memory 104 comprises a memory array 106. Optionally, the security circuitry 100 may comprise a response output 110 for outputting a response signal R. Optionally, the security circuitry 100 may comprise debiasing circuitry 114. Optionally, the security circuitry 100 may receive the challenge signal C from host circuitry 112.

As noted above, the security circuitry 100 is configured to receive the challenge signal C at the challenge input 102. The challenge signal C may be in the form of a bitstring. The processing circuitry 108 is configured to transform the challenge signal C into a transformed signal according to one of more of the transformation operations described herein. The transformation operation may alternatively be described as an expansion operation, as the codebook of the transformed signal may be larger than the codebook of the challenge signal C. For example, the bit-width of the transformed signal may be larger than the bit-width of the challenge signal C. The terms expansion and transformation are taken herein to both refer to this operation, as performed by the processing circuitry 108.

The processing circuitry 108 is further configured to generate the response signal R based on the transformed signal T and the memory 104, according to one or more of the generation operations described herein.

As noted above, the security circuitry 100 may additionally comprise debiasing circuitry 114. The debiasing circuitry 114 may be configured to debias the transformed signal T. For example, the debiasing circuitry 114 may implement Von Neumann debiasing or hashing. Such techniques may result in an unbiased transformed signal which is less susceptible to attack. However, it will be appreciated that such debiasing techniques also tend to be lossy, such that they may result in some bits of the transformed signal being discarded.

While the security circuitry 100 is shown receiving a challenge from and outputting a response to the host circuitry 112, the security circuitry 100 may be implemented in other configurations. The security circuitry 100 may, for example, receive the challenge signal C from one device and transmit the response signal R to another (e.g. separate) device. Alternatively, the security circuitry 100 may generate the response signal R without outputting the response signal R to host circuitry 112, or the host circuitry 112 and security circuitry 100 may be part of a single component such as a security integrated circuit (IC). The security circuitry 100 may be provided as part of a device, IC, module, system or the like, in various embodiments configured to perform the operations as described herein.

As noted above, the memory 104 may comprise the memory array 106. The memory array 106 may be implemented using any known memory addressing architecture.

FIG. 2 is an illustration of an example implementation of the memory array 106 of the memory shown in FIG. 1. The memory array 106 may comprise one or more entries 202, 204, 206, 208. Each entry 202, 204, 206, 208 in the memory array 106 may have an associated memory address 210, 212, 214, 216. Each column of the memory array 106 may have a column address 218, 220, and each row of the memory array 106 may have a row address 222, 224.

Optionally, one or more entries of the memory array 106 may itself be implemented using a physically unclonable function (PUF). In the example shown in FIG. 2, the entry 204 is represented by a one-bit PUF 218. It will be appreciated that any of the other entries 202, 206, 208 may be similarly represented. For example, all of the entries 202, 204, 206, 208 may be implemented using PUFs or PUF devices.

In any case, where the memory array 106 comprises at least one PUF or PUF device, such an array may be referred to herein as a PUF memory array.

The one-bit PUF 218 may generate a single, unique digital bit (e.g. a “0” or a “1”) based on its internal (i.e. natural) entropy. Such entropy is typically sourced through inherent random process variations during manufacture which result in variations in the microelectronic structure of components of the PUF 218 such as transistors. The skilled person will appreciate that any known embodiment of PUF architecture may be implemented in a PUF memory array, and that the memory array 106 is not limited to use with one-bit PUF elements 218.

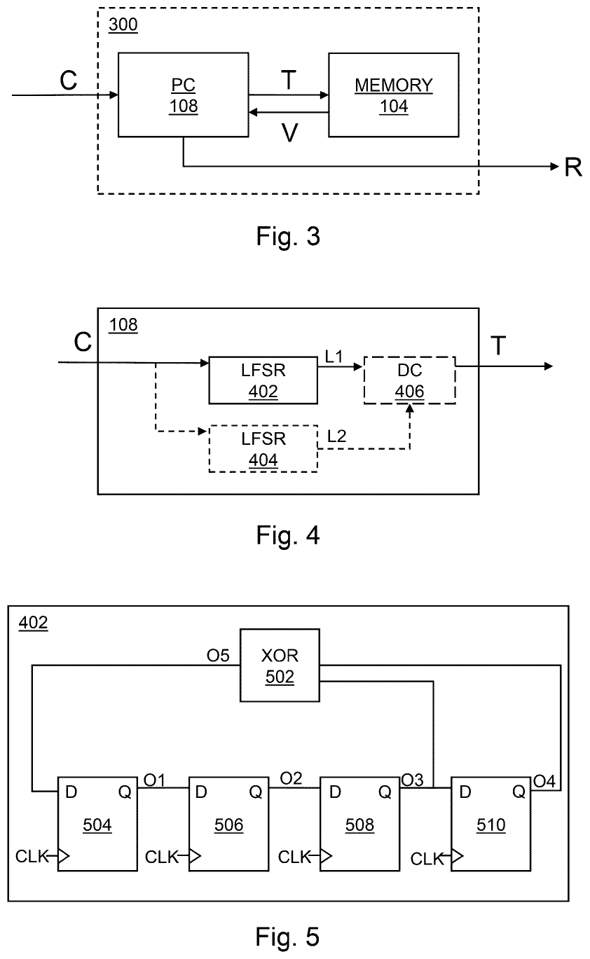

FIG. 3 is an example implementation of a process chain 300 which may be implemented by components of the security circuitry 100 for generating the response signal R based on the challenge signal C comprising the processing circuitry 108 and the memory 104, according to various embodiments of the present disclosure.

The processing circuitry 108 is configured to receive the challenge signal C and transform the challenge signal C into the transformed signal T. The processing circuitry 108 is further configured to generate the response R based on the transformed signal T. Generating the response signal R comprises the processing circuitry 108 interacting with the memory 104 to obtain values V of entries in the memory 104 which may be used to generate the response signal R. The nature of the interaction between the processing circuitry 108 and memory 104 is determined by the transformed signal T, as will be described in more detail below.

The processing circuitry 108 performs a transformation operation to transform the challenge signal C into the transformed signal T. The transformed signal T may represent a sequence of memory addresses. The sequence of memory addresses may be a sequence of the memory addresses 210, 212, 214, 216 of the memory array 106. Optionally, the number of memory address 210, 212, 214, 216 in the sequence of memory address is equal to the bit-width of the challenge signal C. For example, the bit-width of the challenge signal C may be Y, and the transformed signal T may represent Y memory addresses 210, 212, 214, 216. Optionally, each bit in the challenge signal C may be transformed by the processing circuitry 108 into a respective one of the memory addresses 210, 212, 214, 216 represented by the sequence of memory addresses. In which case, the transformed signal T may comprise the sequence of memory addresses.

The memory addresses 210, 212, 214, 216 may be represented by an indexing system. For example, each memory address 210, 212, 214, 216 may be a two-bit number comprising a column address and a row address. Each memory address 210, 212, 214, 216 may be represented by any fixed number of bits, N. The maximum number of memory addresses 210, 212, 214, 216 representable by the indexing system may be at most equal to the number of entries 202, 204 in the memory array 106. For example, the memory addresses 210, 212, 214, 216 may be represented by N bits, drawn from a vocabulary of A characters, where A is a positive integer, such that A^{N}≤X, where X is the number of entries 202, 204, 206, 208 in the memory array 106.

The processing circuitry 108 may be configured to transform the challenge signal C such that the size of the codebook of the transformed signal T is larger than the size of the codebook of the challenge signal C. The codebook of a signal as referred to herein may be taken as a set of all possible codewords that can represent a signal for transmission over a channel. The transformation operation performed by the processing circuitry 108 may comprise expanding the challenge signal C to obtain a transformed signal T. Expanding the challenge signal C to obtain a transformed signal T comprises forming a transformed signal T with a greater bit-width than the challenge signal C. For example, the bit-width of the challenge signal may be Y, and the bit-width of the transformed signal maybe M, wherein M>Y.

Optionally, the transformed signal T may be monitored to avoid duplication of addresses in the transformed signal T. For example, where the transformed signal T comprises multiple of the same memory address (i.e. one or more duplicated memory addresses), the processing circuitry 108 may be configured to remove those duplicated memory addresses from the transformed signal T. Alternatively, duplications or memory addresses may be kept such that the response signal R may comprises one or more duplicated entries from the memory 104.

The processing circuitry 108 is configured to generate a response signal R based on the entries 202, 204, 206, 208 in the memory array 106 at the memory addresses 210, 212, 214, 216 represented by the transformed signal T. Generating the response signal R may comprise concatenating the entries 202, 204, 206, 208 at the sequence of the memory addresses represented by the transformed signal T. Alternative embodiments of the processing circuitry 108 may generate a response signal R based on the entries 202, 204, 206, 208 at the sequence of the memory addresses represented by the transformed signal T using alternative operations. For example, the entries 202, 204, 206, 208 in the memory array 106 at the memory addresses 210, 212, 214, 216 represented by the transformed signal T may represent a data set from which a response signal R is selected by any deterministic mapping between entries 202, 204, 206, 208 in the data set and the response signal R.

As noted above, the processing circuitry 108 may be configured to generate the transformed signal T based on the challenge signal C using any manner of techniques. Non-limiting examples of such techniques shall now be described with reference to FIGS. 4, 6, and 7.

FIG. 4 is a schematic diagram of an example implementation of the processing circuitry 108. In this example, the processing circuitry 108 comprises one or more LFSRs 402, 404. The LFSRs 402, 404 may be LFSRs as described herein with reference to FIG. 5, or any commonly known LFSR architecture. In this example, two LFSRs 402, 404 are provided, but embodiments are not so limited and more or fewer than the two LFSRs 402, 404 may alternatively be provided. Optionally, where multiple LFSRs 402, 404 are provided, the processing circuitry 108 may comprise decision circuitry 406, the operation of which will be described in detail below.

The processing circuitry 108 is configured to transform the challenge signal C to form the transformed signal T. The transformed signal T may be based on respective outputs L1, L2 of the LFSRs 402, 404. The LFSRs 402, 404 may be configured to receive the challenge signal C as a seed. Alternatively, each of the one or more LFSRs 402, 404 may receive a portion of the challenge signal C as a seed.

When the one or more LFSRs 402, 404 comprises a plurality of LFSRs 402, 404, the processing circuitry 108 may select, based on the challenge signal C, one or more LFSRs to generate the transformed signal T. For example, the challenge signal C may include selection bits to determine which of the LFSRs 402, 404 is used to transform the challenge signal C into the transformed signal T. In an example embodiment, the processing circuitry 108 may configure the decision circuitry 406 to forward the chosen output L1, L2 to form the transformed signal T.

Additionally, or alternatively, properties of the challenge signal C may be used to select which LFSR 402,404 is to be used to generate the transformed signal T. Non-limiting examples of such properties include the value of a parity bit, or properties of the challenge signal C following a deterministic operation, such as an XOR with a key word. Where the one or more LFSRs 402, 404 comprises a plurality of LFSRs 402, 404, each LFSR 402, 404 may have a different LFSR polynomial. The LFSR polynomial may be a characteristic equation of an LFSR as is described herein with reference to FIG. 5.

FIG. 5 is schematic diagram of an example implementation of the LFSR 402. The LFSR 404 or any additional LFSR (not shown) may be similarly implemented.

The LFSR 402 comprises an XOR gate 502 and a plurality of edge triggered flip flops 504, 506, 508, 510 (in this case four).

Each of the flip flops 504:510 is configured to receive a clock input CLK. Typically, the flip flops 504:510 are operated on a synchronized clock signal, such that each of the flip flops 504:510 receives the same clock signal CLK. The data input D of a first flip flop 504 may be connected to the output O5 of the XOR gate 502. The output O1 of the first flip flop 504 may be input to the data input D of a second flip flop 506. The output O2 of the second flip flop 506 may be input to the data input D of a third flip flop 508. The output O3 of the third flip flop 508 may be input to the data input D of a fourth flip flop 510. The input to the XOR gate 502 may be formed from the outputs O3, O4 third and fourth flip flops 508, 510.

The flips flops 504:510 may be seeded with an initial value. The initial value determines the value of the outputs O1, O2, O3, O4 (0 or 1) of the flip flops 504:510 at the start of the first clock cycle for each of the flip flops 504:510. Data transition may occur on a clock edge. Typically, the LFSR 402 is cycled for a fixed, predetermined number of clock cycles. Accordingly, the LFSR 402 produces a pseudo-random bit stream formed from an initial seed signal. The output signal L1 of the LFSR 402 may be generated by sampling the output O4 of the fourth flip flop 510. Additionally, or alternatively, the outputs O1, O2, O3 of the first to third flip flops 504:508 may be sampled in a predetermined manner to generate the output signal L1.

Alternative implementations of the LFSR 402 may be used in example embodiments of security circuitry 100. For example, any circuitry functioning to generate a pseudo-random bit stream based on linear feedback of a seed signal may be utilised as any one of the one or more LFSRs 402, 404.

LFSRs such as the LFSR 402 may be represented by a characteristic polynomial, conventionally referred to has an LFSR polynomial. The LFSR polynomial is a mathematical polynomial that defines the structure and behaviour of an LFSR. The security circuitry 100 may comprise one or more LFSRs 402 as described herein. Alternative embodiments of security circuitry 100 may comprise any commonly known variants of LFSR architecture.

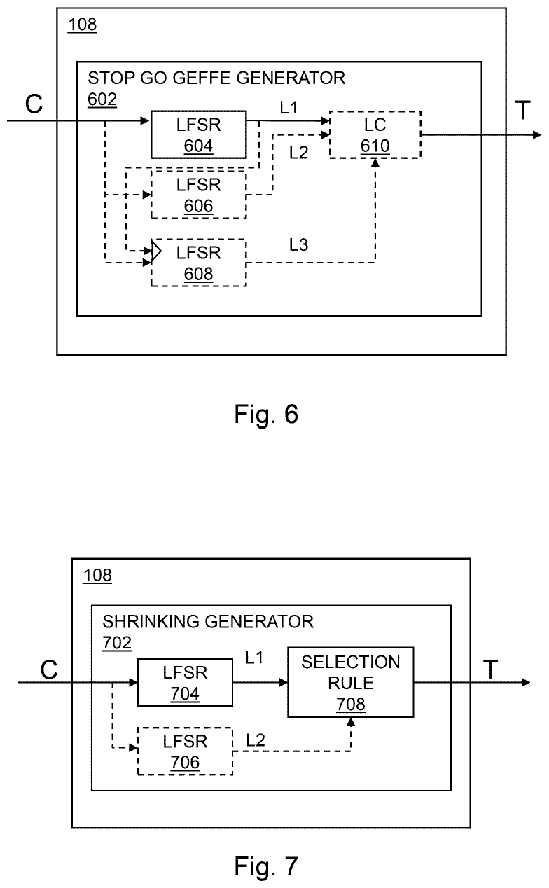

FIG. 6 is a schematic diagram of another example implementation of the processing circuitry 108. The processing circuitry 108 comprises a Stop-Go Geffe generator 602. The Stop-Go Geffe generator 602 may comprise three or more LFSRs 604, 606, 608. Each of the three or more LFSRs 604, 606, 608 may output an output signal L1, L2, L3. The Stop-Go Geffe generator 602 may comprise logic circuitry 610.

The Stop-Go Geffe generator 602 may be configured to transform the challenge signal C to form a transformed signal T. Each of the three or more LFSRs 604, 606, 608 may be initialized with a portion of the challenge signal C. Alternatively, each of the three or more LFSRs 604, 606, 608 may be initialized with the challenge signal C. The logic circuitry 610 may be configured to combine each of the output signals O1, O2, O3 to form the transformed signal T.

A Stop-Go Geffe generator 602 is a combination of a Stop-Go (or Stop-and-Go) generator, and a Geffe generator. Stop-Go and Geffe generators are known in the art and may be embodied as is described herein.

In general, a Geffe generator is a digital circuit configured to implement a cryptographic stream cipher by combining outputs of a plurality of LFSRs using a non-linear function.

In general, a Stop-Go generator is a clock-controlled generator which may comprise a plurality of LFSRs, the output of a first of the LFSRs used to clock a second of the LFSRs. The second LFSR may thereby operate asynchronously to the regular clock cycle.

The Stop-Go Geffe Generator 602 combines the functionality of the Stop-Go Geffe generators by implementing Stop-Go style clocking in addition to combining LFSR outputs using a non-linear function.

Thus, each of the LFSRs 604, 606, 608 are configured to receive the challenge signal C. Outputs L1, L2, L3 of the respective LFSRs 604, 606, 608 are provided to the logic circuitry 610 which configured to combine the outputs L1, L2, L3 of the plurality of LFSRs 604, 606, 608 to produce a non-linear output stream. In the example embodiment shown in FIG. 6, the output stream forms the transformed signal T. An example Geffe generator may comprise three LFSRs 604, 606, 608. The outputs L1, L2, L3 of the three LFSRs 604, 606, 608 may be combined through a function implemented by the logic circuitry 610. The logic circuitry 610 may implement a nonlinear function. The logic circuitry 610 may be implemented using Boolean logic components such as XOR and AND gates. For example, the logic circuitry 610, may act on the outputs L1, L2, L3 to form the transformed signal T, as T=O1(1⊕O2)⊕(O2∧O3). The skilled person will understand that other non-linear output functions may be implemented to combine the outputs L1, L2, L3 of the LFSRs 604, 606, 608.

To implement Stop-Go functionality, the clock cycle of one of the LFSRs 604, 606, 608 may be controlled by the output of another of the LFSRs. This combination provides the benefits of nonlinearity and asynchronous clocking.

It will be appreciated that variations in design of the Stop-Go Geffe generator 602 may be considered. For example, there may be more or fewer LFSRs, multiple asynchronous clocking operations, multiple linear or nonlinear combination functions, or any combination thereof.

FIG. 7 is a schematic diagram of another example embodiment of processing circuitry 108. In this example, the processing circuitry 108 comprises a shrinking generator 702. The shrinking generator 702 may comprise one or more LFSRs 704, 706 and selection rule circuitry 708. In this example, first and second LFSRs 704, 706 are provided, but embodiments are not limited to two LFSRs. A shrinking generator is a concept known to the art and may be embodied as described herein.

Each of the first and second LFSRs 704, 706 may be configured to receive the challenge signal C as a seed. Outputs L1, L2 of the first and second LFSRs 704, 706 are provided to the selection rule circuitry 708 which is configured to output the transformed signal T based on the outputs L1, L2.

The first LFSR 704 may be configured to generate an output sequence L1 based on a seed. The bits of output L1 may be termed candidate bits. The second LFSR 706 may be configured to produce a second output L2. Bits of the output L2 may be termed selector bits.

For example, the second LFSR 706 may output a sequence L2=(s₀, s₁, s₂, . . . , sₙ) where ∀i∈{1,2,3, . . . n}:sᵢ∈{0,1}. Correspondingly, the first LFSR 704 may generate the output sequence L1=(a₀, a₁, a₂, . . . , aₙ) where ∀i∈{1,2,3, . . . n}:aᵢ∈{0,1}. The outputs L1, L2 may be input to the selection rule circuitry 708. The selection rule circuitry 708 may be configured such that, for all indices i where sᵢ=1, the entry aᵢ may be discarded. The output L2 may be a pseudo-random bit stream. The bits of the output L1 chosen for removal (decimation) and the bits chosen for keeping may therefore be irregularly spaced. The shrinking generator 702 may therefore be classed as implementing irregular decimation.

The skilled person will appreciate that other variants of shrinking generators 702 may be implemented, including but not limited to, use of multiple candidate bits sequences, multiple selector bit sequences, and logical functions to implement such configurations.

It will be appreciated that many challenge-response architectures, such as security circuitry 100, are vulnerable to side channel attacks. Side channel attacks are methods of exploiting the physical characteristics of cryptographic systems, such as challenge-response systems. Such attacks measure the physical properties of the circuitry to determine information pertaining to the data being processed.

An example of a common side channel attack is a differential power analysis (DPA) attack. DPA is a type of side-challenge attack which exploits variations in the power traces drawn by a target device, such as the security circuitry 100, to determine various features of the target device. It is desirable to provide security circuitry 100 that is robust to side channel attacks, such as DPA. Architecture designs resistant to side channel attacks may be termed side-channel-robust shift register designs.

Various embodiments of processing circuitry 108 may be vulnerable to side channel attacks. Accordingly, various embodiments of processing circuitry 108 as described herein with reference to FIGS. 4, 6, and 7 may be modified to increase resistance to side-channel attacks by providing side-channel-robust shift register designs.

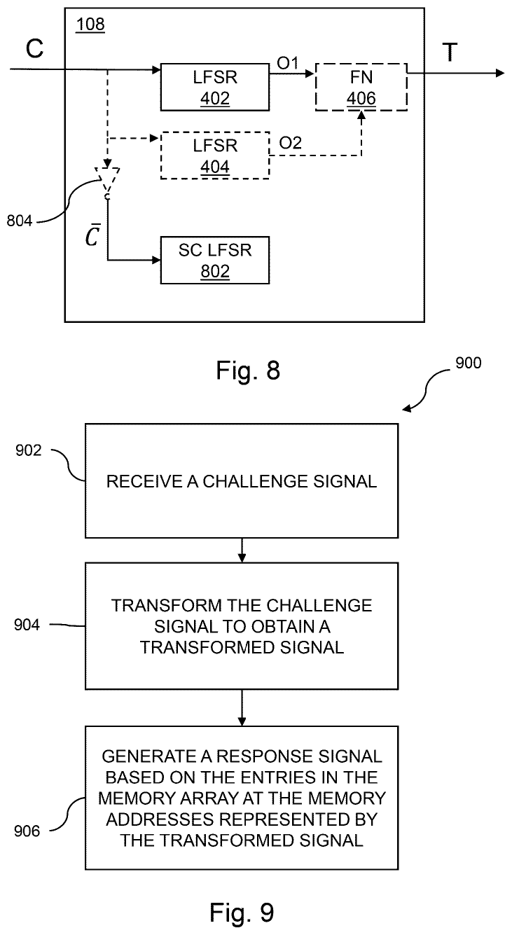

FIG. 8 is a schematic diagram of an example embodiment of processing circuitry 108 which is a variation of the processing circuitry shown in FIG. 4, like parts being denoted with like reference numerals. The processing circuitry 108 of FIG. 8 differs from that of FIG. 4 by the addition of one or more side-channel registers 802. Optionally, the processing circuitry 108 may also comprise an inverter 804.

The one or more side channel registers 802 are configured to receive a signal derived from the challenge signal C, either directly or indirectly via the inverter 804. As such, the one or more side-channel registers may either receive the challenge signal C or a complement C̅ of the challenge signal C, i.e. an inverse challenge signal C̅.

The side channel registers 802 may be configured to process the inverse challenge signal C̅ in parallel to the one or more LFSRs 402, 404. The inverse challenge signal C̅ may be any mathematical inverse or complement of the challenge signal C. For example, if the challenge signal C is a binary signal, the inverse signal C̅ may be formed by passing the challenge signal C through the inverter 804. Such inversion may alternatively be implemented in the one or more side-channel registers 802.

The side channel registers 802 may be configured to perform operations on inverse challenge signal C̅ corresponding to the operations performed by the LFSRs 402 404 on the challenge signal C. Configured in this way, the side channel registers 802 and LFSRs 402 404 may be considered a side-channel-robust shift register design, as the processing circuitry 108 may draw a constant power profile irrespective of the challenge signal C applied. As the power profile is constant, the processing circuitry 108 is resistant to DPA attacks.

The example embodiment of side channel registers 802 shown in FIG. 8 is configured to implement a side-channel-robust shift register design for the expansion circuitry shown in FIG. 4, comprising one or more LFSRs 402, 404. It will be appreciated by the skilled person that similar side-channel-robust shift register designs could be implemented for any of the expansion circuitry configurations shown in FIGS. 6 and 7. It will be appreciated that it is desirable to provide side-channel-robust shift register design for all elements of the processing circuitry 108 irrespective of the implementation of any particular embodiment, or any combination thereof.

The person skilled in the art will appreciate that alternative embodiments of security circuitry 100 may comprise alternative configurations of processing circuitry 108 beyond those described with reference to FIGS. 4, 6 and 7. Any circuitry configured to transform the challenge signal C into the transformed signal T, and generate the response signal R based thereon may be constitute processing circuitry 108. As a non-exhaustive list, a series of alternative embodiments of processing circuitry 108 shall now be described.

Embodiments of the processing circuitry 108 may comprise one or more of the following features: circuitry configured to implement Boolean logic functions; zero padding registers configured to zero pad an input signal; and circuitry configured to implement a cryptographic cypher. Additionally, processing circuitry 108 may access a look-up table. The look-up table may be stored in the memory 104. Operation of each of these will now be described.

The processing circuitry 108 may be configured to implement Boolean logic functions using one or more logic gates, such as an XOR gate. For example, the processing circuitry 108 may implement a fixed Boolean operation, such as an XOR operation, between a received challenge signal C and a secret key. The secret key may be stored in a memory in the processing circuitry 108 or memory external to the processing circuitry 108, such as the memory 104. The secret key may be stored on one or more memory elements such as those described herein. The secret key may be one or more static binary codewords. For example, the secret key may be a binary number with the same bit-width as the challenge signal. The processing circuitry 108 may be configured to perform an XOR operation between the secret key and the challenge signal C to generate a transformed signal T.

The processing circuitry 108 may comprise zero padding registers. The zero padding registers may be configured to pad the challenge signal C to length desired length of the transformed signal T. For example, the challenge signal may be zero padded such that the length of the transformed signal T ensures each bit of the challenge signal C may be transformed into one of the respective memory addresses 210, 212, 214, 216 represented by the transformed signal T as described herein. For example, if each memory address 210, 212, 214, 216is represented by N bits, and the challenge signal C has a bit-width of M, the challenge signal C may be zero padded to a transformed signal T with a bit-width of N×M. A zero-padding operation may comprise adding zeros to the start of a signal, the end of a signal or across predetermined locations in the signal. The challenge signal C may alternatively be padded to a length either longer or shorter than the desired length of the transformed signal T. The processing circuitry 108 may be configured to implement multiple rounds of zero padding.

The processing circuitry may be configured to pass the zero-padded challenge signal into a cryptographic cypher. The cryptographic cypher may comprise any cypher that is one-way or difficult to invert. Examples of such cryptographic cyphers include a cryptographic hash and a Fiestel-style cypher. The cryptographic cypher may be implemented by the circuitry processing circuitry 108. The processing circuitry 108 may implement an exact or approximate form of any cryptographic cypher. For example, the processing circuitry 108 may pass the zero-padded challenge through a plurality of rounds of the Fiestel cypher. A Fiestel-style cypher is a cryptographic cypher known to the art and may be embodied as described herein.

In summary, a Fiestel cypher is a symmetric structure used to construct block cyphers. When implemented, a Fiestel cypher may receive the challenge signal C and split the challenge signal into a left and a right half. The Fiestel cypher may have access to a sequence of round keys. For each round of a series of rounds, the right half may be inputted to a round function along with a round key from the sequence of round keys. An XOR operation may be performed between the output of this round function and the left half. The output of the XOR gate maybe taken as the new right half, while the new left half maybe taken as the right half of the previous round. Typically, a plurality of rounds of such as cypher are performed. The skilled person will appreciate that other embodiments of Fiestel-type cypher algorithms may be implemented. Additionally, or alternatively, other cryptographic cypher types may be formulated by the processing circuitry 108.

The processing circuitry 108 may access a look-up table. The look-up table may be configured to implement an S-box style mapping. For example, the look-up table may be an m by n S-box. An m by n S-box will receive an m bit input signal and output an n bit output signal. For example, the challenge signal C may be a binary signal with a bit-width of m. The look-up table may be an m-by-m table, wherein each entry in the table is an n bit transformed signal. The skilled person will appreciate that alternative S-Box configurations may be implemented using any of the processing circuitry 108.

The embodiments of processing circuitry 108 provided herein described with reference to FIGS. 4, 6 and 7 may each be used in isolation or in combination with one another. For example, the processing circuitry 108 may combine element of the embodiments described with reference to FIGS. 4, 6, and 7. Additionally, or alternatively, the processing circuitry 108 may combine multiple instances of the embodiments as described with reference to FIGS. 4, 6 and 7. For example, the processing circuitry may comprise a plurality of Stop-Go Geffe generators 602. Additionally, or alternatively, various embodiments may operate on the challenge signal C in parallel, with the transformed signal T formed based on the outputs of each of the parallel branches. It will be appreciated by the person skilled in the art that it is advantageous to provide side channel robust designs for all implementations of processing circuitry 108.

Advantageously, example embodiments of the processing circuitry 108 described herein may increase the linear complexity of the transformation operation in comparison to standard response generations mechanisms. Processing circuitry 108 may introduce non-linearity in the response generation function, increasing the linear complexity of the response generation mechanism.

FIG. 9 is a flow diagram showing a method 900 of receiving a challenge signal C and generating a response signal R.

The method 900 comprises, in step 902, receiving a challenge signal C. The challenge signal may be received at the challenge input 102 of the security circuitry 100 according to the various embodiments described herein.

In step 904, the method 900 comprises transforming the challenge signal C to obtain a transformed signal T. Step 904 may be performed using the processing circuitry 108 as described herein. The transformation may be an expansion, wherein the size of a codebook associated with the transformed signal T is larger than a size of the codebook associated with the challenge signal C.

In step 906, the method comprises generating a response signal R based on the entries 202, 204 in the memory array 106 at the memory addresses 206, 208 represented by the transformed signal T. Generating the response signal R may be performed by the processing circuitry 108 described herein.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus, the code may comprise conventional program code or microcode or, for example code for setting up or controlling an ASIC or FPGA. The code may also comprise code for dynamically configuring re-configurable apparatus such as re-programmable logic gate arrays. Similarly, the code may comprise code for a hardware description language such as Verilog TM or VHDL (Very high-speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general-purpose processor or the like. A module may itself comprise other modules or functional units. A module may be provided by multiple components or sub-modules which need not be co-located and could be provided on different integrated circuits and/or running on different processors.

Embodiments may be implemented in a host device, especially a portable and/or battery powered host device such as a mobile computing device for example a laptop or tablet computer, a games console, a remote control device, a home automation controller or a domestic appliance including a domestic temperature or lighting control system, a toy, a machine such as a robot, an audio player, a video player, or a mobile telephone for example a smartphone.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. Circuitry, comprising:
a challenge input for receiving a challenge signal;
a memory comprising a memory array, wherein each entry in the memory array has a memory address; and
processing circuitry configured to:
transform the challenge signal to obtain a transformed signal, wherein a bit-width of the transformed signal is larger than a bit-width of the challenge signal, the transformed signal representing a sequence of the memory addresses;
generate a response signal based on the entries in the memory array at the memory addresses represented by the transformed signal.

2. The circuitry of claim 1, wherein:
one or more of the entries is stored in a one-bit memory element whose state is defined by its natural entropy.

3. The circuitry of claim 1, wherein generating a response signal comprises concatenating entries at the sequence of the memory addresses represented by the transformed signal.

4. The circuitry of claim 1, wherein:
the number of memory addresses in the memory array is greater than the number of memory addresses in the sequence of memory addresses.

5. The circuitry of claim 1, wherein each bit in the challenge signal is transformed by the processing circuitry into a respective one of the memory addresses represented in the transformed signal.

6. The circuitry of claim 1, wherein the processing circuitry is configured to:
monitor the transformed signal;
detect duplication of one or more of the memory addresses in the sequence; and
discard the duplications in the transformed signal before generating the response.

7. The circuitry of claim 1, wherein the processing circuitry is configured to transform the challenge signal such that the sequence comprises Y addresses, each having N bits, where A^{N}≤X, where A is a positive integer, and where X is the number of entries in the memory array.

8. The circuitry of claim 1, wherein the processing circuitry comprises one or more linear feedback shift registers (LFSRs).

9. The circuitry of claim 8, wherein the one or more LFSRs are configured to receive the challenge signal as a seed.

10. The circuitry of claim 8, wherein, the one or more LFSRs comprises a plurality of LFSRs, and wherein the processing circuitry is configured to select, based on the challenge signal, one or more of the plurality of LFSRs to generate the transformed signal.

11. The circuitry of claim 10, wherein each of the plurality of LFSRs has a different LFSR polynomial.

12. The circuitry of claim 1, wherein the processing circuitry comprises a Stop-Go Geffe generator.

13. The circuitry of claim 12, wherein the Stop-Go Geffe generator comprises three or more LFSRs, each of the LFSRs initialized with a portion of the challenge signal.

14. The circuitry of claim 1, wherein the processing circuitry comprises a shrinking generator.

15. The circuitry of claim 14, wherein the shrinking generator comprises a plurality of LFSRs and is configured to implement irregular decimation.

16. The circuitry of claim 14, wherein the shrinking generator comprises a non-deterministic generator, comprising:
a first LFSR configured to generate candidate bits; and
a second LFSR configured to select a subset of the candidate bits.

17. The circuitry of claim 1, wherein the processing circuitry is configured to transform the challenge signal by performing one or more of the following:
accessing a look up table mapping the transform;
implementing a fixed Boolean operation using one or more logic gates;
implementing zero padding using one or more registers; and
passing the challenge signal through a cryptographic cypher.

18. The circuitry of claim 17, wherein the cryptographic cypher comprises a Feistel-type cypher, and wherein the processing circuitry is configured to:
zero-pad the challenge signal to obtain an expanded challenge signal; and
pass the expanded challenge signal through a plurality of rounds of the Feistel-type cypher.

19. The circuitry of claim 1, wherein the processing circuitry is configured to implement the transform using a side-channel-robust shift register design.

20. The circuitry of claim 8, wherein the processing circuitry comprises one or more side-channel LFSRs configured to process an inverse of the challenge signal in parallel to a respective one of the one or more LFSRs.

21. The circuitry of claim 1, wherein the processing circuitry is configured to debias the transformed signal prior to generating the response.

22. The circuitry of claim 1, further comprising:
an output configured to output the response signal.

23. A physically unclonable function (PUF), comprising:
the circuitry of claim 1.

24. An electronic device, comprising:
the circuitry of claim 1.

25. The electronic device of claim 24, further comprising:
host circuitry configured to generate the challenge signal and receive the response signal.

26. The electronic device of claim 24, wherein the device comprises one of a smartphone, a communications device, a mobile computing device, a laptop computer, a tablet computer, a games console, a remote-control device, a home automation controller or a domestic appliance, a toy, a robot, an audio player, a video player, and a mobile telephone.

27. A method of generating a response signal using a memory comprising a memory array, each entry in the memory array having a memory address, the method comprising:
receiving a challenge signal;
transforming the challenge signal to obtain a transformed signal, wherein a bit-width of the transformed signal is larger than a bit-width of the challenge signal, the transformed signal representing a sequence of the memory addresses;
generating the response signal based on the entries in the memory array at the memory addresses represented by the transformed signal.
